(19) United States
(12) Patent Application Publication
(10) Pub. No.: US 2003/0225656 A1
(43) Pub. Date: Dec. 4, 2003

(54) Financial instruments and methods

(75) Inventors: Robert Aberman, Passaic, NJ (US); Stuart C. Kaperst, New York, NY (US); Todd K. Kaplan, Winnetka, IL (US); Jonathan Krissel, New York, NY (US); Russell L. Stein, Englewood Cliffs, NJ (US)

Correspondence Address: OPPEDAHL AND LARSON LLP, P O BOX 5068, DILLON, CO, 80435-5068, US

(73) Assignee: MERRILL LYNCH AND CO. INC., New York, NY (US)

(21) Appl. No.: 10/249,884

(22) Filed: May 14, 2003

(51) Int. Cl. G06F 17/60

(52) U.S. Cl. 705/36

(57) ABSTRACT

A business entity creates a real estate investment trust. The trust issues shares of preferred stock, each of which is associated with either a forward purchase contract obligating the holder to purchase common stock of business entity at a predetermined future time, or a warrant to purchase common stock. The preferred stock of the trust may be exchangeable for capital stock of the business entity upon the occurrence of a predetermined event. In this way the entity is able to insert capital with significant equity characteristics into its capital structure, and in the case of a financial institution, can provide favorable regulatory treatment of the capital that is raised.

### BACKGROUND OF INVENTION

The invention relates generally to financial instruments and methods used therewith, and relates more particularly to instruments and methods making use of real estate investment trusts.

Capital structure. Businesses often raise capital in several different ways, including debt and equity capital and other approaches falling between the two. For any particular business its capital structure may significantly affect its regulatory status, its ability to borrow money, and other aspects of flexibility in financial planning.

In the case of a financial institution, its capital structure is typically evaluated in relation to certain risk-based capital ratio and leverage ratio guidelines issued by the Federal Reserve Board, the Office of Comptroller of the Currency, office Office of Thrift Supervision, the Federal Deposit Insurance Corporation, or banking regulators of the various states. For other regulated institutions the regulator may be for example the Securities and Exchange Commission and for insurance companies, the various state insurance regulators. As will be discussed in some detail below, the benefits of the invention may offer themselves to any business entity that is regulated by a regulator as to its capitalization, including banks and insurance companies, and thus in this context the term “financial institution” will generally be used as a shorthand for “an institution regulated by a regulator with respect to its capitalization. As will be discussed below, in an exemplary embodiment a financial institution may be a commercial bank.

Generally, a financial institution's capital is divided into two tiers. Tier 1 capital typically includes common equity, noncumulative perpetual preferred stock, and minority interests in equity accounts of consolidated subsidiaries, less nonqualifying intangible assets such as goodwill and nonqualifying mortgage and non-mortgage servicing assets. Tier 2 capital typically includes, among other things, cumulative and limited-life preferred stock, hybrid capital instruments, mandatory convertible securities, qualifying subordinated debt, and the allowance for loan and lease losses, subject to certain limitations. Total capital is the sum of Tier 1capital plus Tier 2 capital. The leverage ratio is the ratio of Tier 1capital to adjusted average total assets.

On one measure, an institution may be considered “adequately capitalized” if it has a total risk-based capital ratio of at least 8.0%, a Tier 1 risk-based capital ratio of at least 4.0% and a leverage, or core capital, ratio of at least 4.0% or at least 3.0% if the institution has been awarded the highest supervisory rating. An institution may be considered “well-capitalized” if the foregoing ratios are at least 10.0%, 6.0%, and 5.0%, respectively. The Federal Reserve Board guidelines relating to Tier 1 and Tier 2 capital have been in effect for more than ten years.

For many corporations that are not financial institutions, the capital structure of the corporation will affect the corporation's flexibility and ability to raise money from capital markets as well as the cost-effectiveness thereof. Among other things, the capital structure will affect the ratings that rating agencies will give to its financial instruments. For each financial instrument issued by an entity, a rating agency may evaluate the amount of “equity credit” to give to the instrument. In a simple case, for example, a rating agency will generally give 100% equity credit for common stock, 50% equity credit for preferred stock, and no equity credit for a pure debt offering. This equity credit contributes to ratios which influence the ratings which a rating agency is willing give to the corporation's financial instruments.

It will thus be appreciated by those skilled in the art that business entities have good reason to devote substantial attention to their capital structure. A financial institution has reason to make sure that enough of its capital is Tier 1 capital. Other corporations have reason to seek a capital structure that prompts ratings agencies to view them favorably.

Taxation. Those who design financial instruments must necessarily consider the likely tax treatment for any particular proposed financial instrument or method. In the United States, for example, for most corporations the dividends paid to shareholders are not. tax-deductible for the corporation. This leads to what is commonly termed “double taxation,” in which income is taxed first at the corporation and then, after dividends are paid, is taxed a second time at the shareholders who receive the dividends.

REITs. A real estate investment trust (“REIT”) is a company dedicating to owning certain types of assets, generally land, buildings, and mortgages, established to comply with provisions of US tax law that provide favorable tax treatment if certain conditions are met. (These types of assets, land, buildings, and mortgages relating thereto, may be termed “real-estate-related assets.” or “REIT-eligible assets.”) The detailed provisions of US tax law relating to REITs are well known to those skilled in the art. Chiefly, to be a REIT the company is required to pay nearly all of its income (at least 90%) to shareholders in the form of dividends. The REIT must have at least one hundred shareholders. The REIT must not be controlled by five or fewer individuals. Importantly, under US law the REIT is permitted to deduct from its income (for purposes of federal corporate income tax) the dividends paid to shareholders. In an exemplary embodiment a REIT is a corporation which has made an election under US tax law to be treated as a REIT. REITs have been in existence for over a decade. In this context the term “real estate investment trust” will often be used as a shorthand for “a corporation which has elected to be treated as a real estate investment trust.”

As is well known to those skilled in the art, REIT-eligible assets are generally defined as land, buildings, and inherently permanent structures. (Inherently permanent structures are defined structures that are incapable of being moved, that are designed to remain permanently in place, that have a high expected or intended length of affixation, that would require substantial time and effort to remove, that would sustain significant damage if moved, and not reusable at a different site.) Such REIT-eligible assets also include mortgages on real property. Excluded are assets accessory to the operation of a business, such as machinery and assets connected to machinery.

Under US tax law, satisfaction of certain requirements provides for a REIT to be tax-exempt from a corporate-level income tax and will allow the deductibility of its dividend payments. Unlike a regular corporation which pays dividends from after-tax income, the REIT is able to to pay its dividends from pretax income thereby resulting in only one layer of tax at the investor level.

It would be extremely desirable if a financial instrument could be devised which would permit an entity to attract investment relating to its real estate assets, which investment would not be subject to double taxation, and which instrument would have a favorable effect on the entity's capital structure. Simply setting up a REIT, without more, would not serve all of these several goals. If done by a financial institution, setting up the REIT would not favorably affect the Tier 1 capital position of the institution. If done by a company that is not a financial institution, setting up the REIT would not provide equity credit. There has thus been a long-felt need for such financial instruments.

Those skilled in the art will appreciate that a corporation which has elected to be treated as a REIT must monitor its circumstances so as to continue to qualify as a REIT. For example the corporation may need to monitor the concentration of its ownership (the portion of the corporation owned by some number of owners) and the total number of owners. Likewise it may need to monitor to be sure that it distributes at least the required fraction of its income to shareholders. A REIT may do this monitoring itself or the monitoring may be performed by a designee.

Ways in which a company might try to raise money. A company, seeking to raise money in the capital markets, might consider any of a number of approaches.

One prior-art approach could be issuing a series of perpetual preferred shares to investors. While this approach may enjoy accounting treatment as equity and may enjoy a ratings agency equity credit of 50%, the payments to the investors are not tax-deductible for the company.

Another prior-art approach is to issue long-term debt corporate paper, for example 30-year debt, to a trust which in turn issues preferred stock of a corresponding life to investors. While the debt payments are tax-deductible for the company, the accounting treatment is as debt and the rating agency equity credit may be considerably less than 50%.

Neither of these approaches is entirely satisfactory, and it would be extremely desirable if the industrial company could find a way to raise money in the capital markets in which the payments to the investors are tax-deductible, in which the accounting treatment is as equity, and in which the ratings agency equity credit is 50% or more. This need has remained outstanding and unfulfilled for well over a decade.

Ways in which a financial institution might try to raise money. A financial institution, seeking to raise money in the capital markets, might consider any of a number of approaches.

One prior-art approach is a debt offering. This has the advantage that the interest payments are tax-deductible but does not improve the bank's Tier-1 capitalization position. Another approach is to issue common shares, which does improve the Tier-1 capitalization position, but dividend payments to such shareholders are not tax-deductible and the economic cost of issuing common shares is considerable.

Other patents and patent applications. Patents and patent publications discussing some of the concepts mentioned in this background include US patent application publication no. 20020023036 published Feb. 21, 2002 entitled “Method of buying and selling real estate;” US patent application publication no. 20020123960 published Sep. 5, 2002 entitled “Systems, methods and computer program products for offering consumer loans having customized terms for each customer;” U.S. Pat. No. 6,292,788 entitled “Methods and investment instruments for performing tax-deferred real estate exchanges;” U.S. Pat. No. 5,852,811 entitled “Method for managing financial accounts by a preferred allocation of funds among accounts;” international application publication no. WO 02/11026 published Feb. 7, 2002 entitled “A method to enhance the equity of a business entity;” and international application publication no. WO 03/017057 published Feb. 27, 2003 entitled “System and method for evaluating real estate financing structures.”

### SUMMARY OF INVENTION

A business entity creates a real estate investment trust. The trust issues shares of preferred stock, each of which is associated with either a forward purchase contract obligating the holder to purchase common stock of business entity at a predetermined future time, or a warrant to purchase common stock. The preferred stock of the trust may be exchangeable for capital stock of the business entity upon the occurrence of a predetermined event. In this way the entity is able to insert capital with significant equity characteristics into its capital structure, and in the case of a financial institution, can provide favorable regulatory treatment of the capital that is raised.

### BRIEF DESCRIPTION OF DRAWINGS

FIG. 1 is a flow diagram showing an embodiment of the invention.

FIG. 2 is a figurative representation of an investment unit according to the invention.

### DETAILED DESCRIPTION

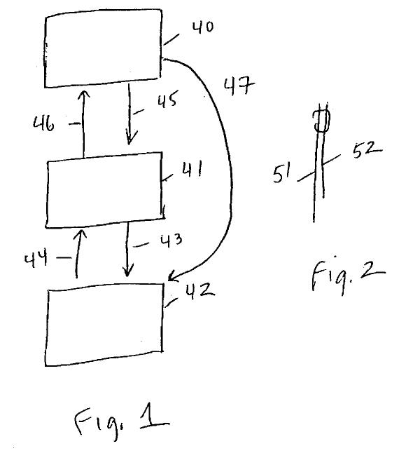

Turning to FIG. 1, what is shown is a flow diagram. The diagram helps to show the steps that are followed in an exemplary embodiment of the invention.

Before the invention is practiced it is assumed that a corporation 40 exists and that it possesses or is able to come to possess some real-estate-related assets. It is assumed further that corporation 40 wishes to raise money in the capital markets.

In accordance with the invention, corporation 40 owns a second entity 41. Entity 41 in a preferred embodiment is a corporation that elects under relevant tax law to be treated as a real estate investment trust (REIT).

As shown at 45, the corporation 40 (sometimes referred to as “the parent”) contributes REIT-eligible assets to the REIT 41 if the REIT 41 does not already possess such assets. In return (in this embodiment) at 46 the REIT 41 issues common stock to the parent 40. (It is possible to imagine fact patterns in which the transfer from the REIT 41 to the parent 40 is a mix of cash and common stock or other securities.) Investors 42 pay cash 44 to the REIT 41, and in return they receive investment units comprised of preferred stock 43 from the REIT and a forward purchase contract or warrant 47 from the parent 40.

The events relating to FIG. 1 may take place in various ways with various timing. In a simple case the formation of the REIT 41 may be contemporaneous with the issuance of the preferred stock 43 and other steps. But nothing about the invention requires that the REIT 41 be formed contemporaneously. For example, the REIT 41 may have been in existence for some years, having been established for other reasons and presently being put to use in connection with the invention. Yet another possible sequence of events may be that a corporation may have been in existence for some years, that had not previously elected to be treated as a real estate investment trust, and that presently elects to be treated as a real estate investment trust in connection with the invention.

The investment units may be understood figuratively as considered as preferred shares 51 of the REIT 41, each of which is stapled or associated with to a forward contract 52, about which more will be said later. It should be appreciated that while the investment units may be physical share certificates, it offers substantial administrative convenience if the units are mere bookkeeping entries in the computer system of an appropriate third party entrusted to keep such entries. Even if the investment units are physical documents, they may be unitary documents rather than the figurative stapled documents portrayed in FIG. 2.

Forward contract A “forward contract” is a contract in which a party promises to pay something of value at some future time. A typical forward contract used in connection with the invention is a contract obligating the holder of the contract to purchase, and obligates the entity to sell, on a particular date, for a specified price, a number of newly issued common stock of the entity according to a formula. The formula may be fixed at the outset or may vary over the life of the security.

Warrant A warrant, in this context, is a contract (also called an “option”) obligating a party to sell something of value to someone else under agreed conditions. Depending on the wording of the warrant, it may for example entitle the holder to purchase the item of value (a) at any time until a stated expiration date, (b) on a particular date, or (c) at any time or particular date within a stated range of dates.

In the context of this invention, it is convenient to define a term “equity contract” which is intended to embrace both forward contracts and warrants. In this way one may consider the investor who holds an investment unit as holder of a share of preferred stock of the REIT, the stock being associated with either a forward contract or a warrant. In the case of the forward contract, one may refer to the share of REIT preferred stock as being “mandatorily convertible” into common stock of the parent. In the case of the warrant, one may refer to the share of REIT preferred stock as being “optionally convertible” into common stock of the parent.

In this context, “an equity contract relating to purchase of common stock of the parent” may mean, for example, “a forward contract obligating the holder to purchase common stock of the first entity at a date in the future” or “a warrant giving the holder an option to purchase common stock of the first entity.” stock of the parent. In an exemplary embodiment, the preferred stock of the REIT is exchangeable, upon certain events, for preferred stock of the parent entity. It will be appreciated, however, that the stock of the parent entity that is the result of the exchange would not necessarily have to be preferred stock. Depending on tax and other factors it would be possible to imagine exchanging into common stock of the parent or into a basket containing preferred and common stock. For this reason it is helpful to use the collective term “capital stock” of the parent to include preferred stock of the parent and common stock of the parent.

Exchange events. In exemplary embodiments of the invention, predetermined conditions are set forth, upon the occurrence of which the preferred shares of the REIT would be exchanged for preferred shares of the parent company.

In one embodiment where the parent is a company that is not a financial institution, the exchange events may include:

failure of the REIT to declare dividends on its preferred stock for a specified period of time;

the maturity or prepayment of the mortgage notes or the transfer or liquidation of any assets with respect to which the parent is the primary obligor or guarantor, and the failure of the parent to refinance such matured or prepaid mortgage notes or to contribute or sell to the REIT within a specified period of time, REIT-eligible assets such that the REIT's aggregate investment income is expected to be sufficient to pay full dividends on the REIT's preferred stock, plus reasonably anticipated expenses;

an event of default in respect of any of the mortgage notes issued by the parent to the REIT at closing or the related mortgage liens or any of the REIT's other assets for which the parent is the primary obligor or guarantor;

the failure of the parent to remain at all times the primary obligor or guarantor in respect of investments accounting for a specified portion of the REIT's investment income;

the failure of the parent to maintain its long-term senior unsecured debt ratings at or above specified levels by specified rating agencies providing such services;

the acceleration of any debt of the parent in a principal amount in excess of a specified amount;

bankruptcy, insolvency or liquidation events of the parent;

the receipt by the REIT of an opinion of counsel, rendered by a law firm experienced in such matters, in form and substance satisfactory to the REIT, which states that there is more than an insubstantial risk that the REIT is or will be considered an “investment company” that is required to be registered under the Investment Company Act, as a result of the occurrence of a change in law or regulation or a written change in interpretation or application of law or regulation by any legislative body, court, governmental agency, or regulatory authority, or the REIT is required to be registered under the Investment Company Act; or

the REIT's failure to qualify as a REIT from the outset, or to remain qualified as a REIT for federal income tax purposes.

In an embodiment where the parent corporation is a financial institution, the exchange events may include:

the financial institution becomes less than “adequately capitalized” according to regulations established by the Federal Reserve Board pursuant to the Federal Deposit Insurance Corporation Act;

the financial institution is placed into conservatorship or receivership;

the Federal Reserve Board directs such exchange in writing, in its sole discretion, and even if the financial institution is not less than “adequately capitalized,” the Federal Reserve Board anticipates that the financial institution will become less than “adequately capitalized” in the near term, or

the Federal Reserve Board, in its sole discretion, directs such exchange in writing in the event that the financial institution has a Tier 1 risk-based capital of less than 5.0%.

As mentioned above, it is noted in this connection that under the regulations of the Federal Reserve Board, a financial institution will be deemed less than “adequately capitalized” if it has a total risk-based capital ratio of less than 8.0%, a Tier 1 risk-based capital ratio of less than 4.0%, and a leverage ratio of less than 4.0% or less than 3.0% if the institution has been awarded the highest supervisory rating.

As will be appreciated, exchange events may include events that are indicative of financial distress on the part of the REIT, or that are indicative of financial distress of the parent, or both.

Example 1. A commercial bank created a REIT, contributing about $300 million in REIT-eligible assets to the REIT and receiving approximately $150 million in cash and common shares of the REIT with approximately $150 million in value. The REIT issued 6 million equity units of preferred stock for about $150 million. The principal business objective of the REIT was and is to acquire, hold and manage commercial mortgage loan assets and other authorized investments from the bank that will generate net income for distribution to its stockholders. The REIT elected to be treated as a real estate investment trust REIT for federal income tax purposes. Each investment unit of the REIT has a stated amount of $25 per unit and is associated with a 3-year forward purchase commitment, also called a purchase contract, as well as with a preferred share of the REIT. Each purchase contract obligates the holder to buy, on Aug. 17, 2005, for $25, a number of newly issued shares of common stock of the bank equal to the “settlement rate.” The settlement rate will be calculated as follows

if the market value of the bank's common stock is equal to or greater than the $29.0598, the settlement rate will be 0.8603;

if the market value of the bank's common stock is between $29.0598 and $24.42, the settlement rate will be equal to the $25 stated amount divided by the applicable market value; and

if the applicable market value is less than or equal to $24.42, the settlement rate will be 1.0238.

“Applicable market value” is defined as the average of the closing price per share of the bank's common stock on each of the twenty consecutive trading days ending on the fifth trading day immediately preceding Aug. 17, 2005.

The forward purchase commitment (also called a “forward contract”) is backed by an arrangement involving the above-mentioned preferred share of the REIT. This preferred share is pledged to satisfy the investor's obligation under the forward contract, if necessary. Thus at the end of the three-year period, one approach for settling the forward contract is that the investor surrenders their preferred share of the REIT and receives the common stock of the parent at the settlement rate. Another approach is that the investor may simply purchase the common stock of the parent, paying cash for the number of shares at the settlement rate. Such an investor ends up owning the preferred share of the REIT as well as the common stock of the parent.

An investor may also participate in a remarketing of their preferred share of the REIT such that the cash proceeds from the remarketing (if successful) may be used to satisfy such investor's obligation.

In this example, the terms of the investment unit are that the holder may pledge a different asset (e.g. a treasury bill) in exchange for the preferred share or shares of the REIT. In that event the holder is free to dispose of the REIT preferred share as desired, or may hold onto the share even after the forward contract is settled at the end of the three-year period.

The economic ownership of the REIT is about 50% to the bank (through its holdings of common shares of the REIT) and about 50% to the investors (through their holdings of preferred shares of the REIT). The voting power of the bank is about 90% and the voting power of the investors is about 10%, due to the limited voting power given to the preferred shares.

the result, for the bank, was the enhancement of its Tier 1 capital as viewed by the Federal Reserve Board. This, combined with tax-deductibility of the dividend payments to the investors, and the ability to become common shares, is a combination not found in prior-art ways of raising money.

Those skilled in the art will have no difficulty devising myriad obvious variations and improvements upon the disclosed embodiments, all of which are intended to fall within the scope of the claims which follow.

1. A method for use in connection with a first entity possessing first assets and for use in connection with a plurality of investors, the method comprising the steps of:
establishing, by the first entity, a second entity holding real-estate-related assets;
issuing preferred stock of the second entity to the plurality of investors, each share of which is associated with an equity contract relating to the purchase by the holder of the preferred stock of common stock of the first entity;
at the second entity, monitoring to determine whether there are one hundred or more owners of the second entity;
at the second entity, monitoring to determine whether fifty percent or more of the second entity is owned by five or fewer owners;
at the second entity, paying out at least ninety percent of income of the second entity to shareholders in the form of dividends.

2. The method of claim 1 wherein the step of establishing the second entity is performed contemporaneously with the issuing of the preferred stock of the second entity to the plurality of shareholders.

3. The method of claim 1 wherein the equity contract is a forward contract obligating its holder to purchase common stock of the first entity at a date in the future.

4. The method of claim 1 wherein the second entity is a real estate investment trust.

5. The method of claim 1 further comprising the step of:
exchanging the preferred stock of the second entity for capital stock of the first entity upon the occurrence of a predetermined event.

6. The method of claim 5 wherein the predetermined event comprises an event indicative of financial distress of the first entity.

7. The method of claim 5 wherein the predetermined event comprises an event indicative of financial distress of the second entity.

8. The method of claim 5 wherein the capital stock for which the preferred stock of the second entity is exchanged is preferred stock of the first entity.

9. A method for use in connection with a first entity possessing first assets and for use in connection with a plurality of investors, the method comprising the steps of:
establishing, by the first entity, a second entity comprising a real estate investment trust; and
issuing preferred stock of the second entity to the plurality of investors, each share of which is associated with an equity contract relating to the purchase by the holder of the preferred stock of common stock of the first entity.

10. The method of claim 9 wherein the step of establishing the second entity is performed contemporaneously with the issuing of the preferred stock of the second entity to the plurality of shareholders.

11. The method of claim 9 wherein the equity contract is a forward contract obligating the holder of the stock to purchase common stock of the first entity at a date in the future.

12. The method of claim 9 wherein the second entity performs the further steps of:
monitoring to determine whether there are one hundred or more owners of the real estate investment trust;
monitoring to determine whether fifty percent or more of the second entity is owned by five or fewer owners;
paying out at least ninety percent of the income of the second entity to shareholders in the form of dividends.

13. The method of claim 9 wherein the second entity performs the further step of:
monitoring such requirements as allow the second entity to continue as a real estate investment trust.

14. The method of claim 9 further comprising the step of:
exchanging the preferred stock of the second entity for capital stock of the first entity upon the occurrence of a predetermined event.

15. The method of claim 14 wherein the predetermined event comprises an event indicative of financial distress of the first entity.

16. The method of claim 14 wherein the predetermined event comprises an event indicative of financial distress of the second entity.

17. The method of claim 14 wherein the capital stock for which the preferred stock of the second entity is exchanged is preferred stock of the first entity.

18. A system comprising first and second business entities;
the first entity comprising a corporation having shares of common stock outstanding;
the second entity comprising a corporation holding real-estate-related assets and deriving income therefrom;
the second entity further characterized as having shares of preferred stock outstanding;
the second entity having no fewer than 100 owners;
the second entity further characterized in that no five or fewer owners own fifty percent or more of the second entity;
the second entity further characterized as paying out no less than ninety percent of its income to shareholders in the form of dividends;
each share of preferred stock of the second entity associated with an equity contract relating to the purchase by the holder of the preferred stock of common stock of the first entity.

19. The system of claim 18 wherein the equity contract is a forward contract obligating its holder to purchase common stock of the first entity at a date in the future.

20. The system of claim 18 wherein the first entity is a financial institution.

21. The system of claim 20 wherein the second entity is a real estate investment trust.

22. The system of claim 20 wherein the preferred stock is exchangeable for capital stock of the first entity upon the occurrence of a predetermined event.

23. The system of claim 22 wherein the predetermined event comprises an event indicative of financial distress of the first entity.

24. The system of claim 22 wherein the predetermined event comprises an event indicative of financial distress of the second entity.

25. The system of claim 22 wherein the capital stock for which the preferred stock of the second entity is exchanged is preferred stock of the first entity.

26. A system comprising first and second business entities;
the first entity comprising a corporation having shares of common stock outstanding;
the second entity comprising a real estate investment trust holding real-estate-related assets and deriving income therefrom;
the second entity further characterized as having shares of preferred stock outstanding;
each share of preferred stock of the second entity associated with an equity contract relating to the purchase by the holder of the preferred stock of common stock of the first entity.

27. The system of claim 26 wherein the equity contract is a forward contract obligating its holder to purchase common stock of the first entity at a date in the future.

28. The system of claim 26 wherein the first entity is a financial institution.

29. The system of claim 26 wherein the first entity is company that is not a financial institution.

30. The system of claim 26 wherein the preferred stock is exchangeable for capital stock of the first entity upon the occurrence of a predetermined event.

31. The system of claim 30 wherein the predetermined event comprises an event indicative of financial distress of the first entity.

32. The system of claim 30 wherein the predetermined event comprises an event indicative of financial distress of the second entity.

33. The system of claim 30 wherein the capital stock for which the preferred stock of the real estate investment trust is exchanged is preferred stock of the first entity.

34. A method for use in connection with a financial institution regulated by the Federal Reserve Board and possessing first assets, the method for use in connection with a plurality of investors, the method comprising the steps of:
establishing, by the financial institution, a second entity holding real-estate-related assets;
issuing preferred stock of the second entity to the plurality of investors, each share of which is associated with an equity contract relating to the purchase by the holder of the preferred stock of common stock of the first entity;
at the second entity, monitoring to determine whether there are one hundred or more owners of the second entity;
at the second entity, monitoring to determine whether fifty percent or more of the second entity is owned by five or fewer owners;
at the second entity, paying out at least ninety percent of income of the second entity to shareholders in the form of dividends;
whereby the Tier 1 or Tier 2 capitalization of the financial institution is increased.

35. The method of claim 34 wherein the step of establishing the second entity is performed contemporaneously with the issuing of the preferred stock of the second entity to the plurality of shareholders.

36. The method of claim 34 wherein the equity contract is a forward contract obligating the holder of the stock to purchase common stock of the financial institution at a date in the future.

37. The method of claim 34 wherein the second entity is a real estate investment trust.

38. The method of claim 34 further comprising the step of:
exchanging the preferred stock of the second entity for capital stock of the financial institution upon the occurrence of a predetermined event.

39. The method of claim 38 wherein the predetermined event comprises an event indicative of financial distress of the financial institution.

40. The method of claim 38 wherein the predetermined event comprises an event indicative of financial distress of the second entity.

41. The method of claim 38 wherein the capital stock for which the preferred stock of the second entity is exchanged is preferred stock of the financial institution.

42. A method for use in connection with a financial institution regulated by a regulator and possessing first assets, the method for use in connection with a plurality of investors, the method comprising the steps of:
establishing, by the financial institution, second entity comprising a real estate investment trust;
issuing preferred stock of the real estate investment trust to the plurality of investors, each share of which is associated with an equity contract relating to the purchase by the holder of the preferred stock of common stock of the first entity;
whereby the Tier 1 or Tier 2 capitalization of the financial institution is increased.

43. The method of claim 42 wherein the step of establishing the real estate investment trust is performed contemporaneously with the issuing of the preferred stock of the real estate investment trust to the plurality of shareholders.

44. The method of claim 42 wherein the second entity performs the further step of:
monitoring such requirements as allow the second entity to continue as a real estate investment trust.

45. The method of claim 42 wherein the equity contract is a forward contract obligating the holder of the stock to purchase common stock of the financial institution at a date in the future.

46. The method of claim 42 wherein the real estate investment trust performs the further steps of:
monitoring to determine whether there are one hundred or more owners of the real estate investment trust;
monitoring to determine whether fifty percent or more of the real estate investment trust is controlled by five or fewer owners;
paying out at least ninety percent of the income of the real estate investment trust to shareholders in the form of dividends.

47. The method of claim 42 further comprising the step of:
exchanging the preferred stock of the real estate investment trust for capital stock of the financial institution upon the occurrence of a predetermined event.

48. The method of claim 47 wherein the predetermined event comprises an event indicative of financial distress of the financial institution.

49. The method of claim 47 wherein the predetermined event comprises an event indicative of financial distress of the real estate investment trust.

50. The method of claim 47 wherein the capital stock for which the preferred stock of the real estate investment trust is exchanged is preferred stock of the financial institution.

51. A system comprising first and second business entities;
the first entity comprising a financial institution regulated by a regulator and having shares of common stock outstanding;
the second entity comprising a corporation holding real-estate-related assets and deriving income therefrom;
the second entity further characterized as having shares of preferred stock outstanding;
the second entity having no fewer than 100 owners;
the second entity further characterized in that no five or fewer owners own fifty percent or more of the second entity;
the second entity further characterized as paying out no less than ninety percent of its income to shareholders in the form of dividends;
each share of preferred stock of the second entity associated with an equity contract relating to the purchase by the holder of the preferred stock of common stock of the first entity;
the financial institution having greater Tier 1 or Tier 2 capitalization than it would have in the absence of the second entity.

52. The system of claim 51 wherein the equity contract is a forward contract obligating its holder to purchase common stock of the financial institution at a date in the future.

53. The system of claim 51 wherein the second entity is a real estate investment trust.

54. The system of claim 51 wherein the preferred stock is exchangeable for capital stock of the financial institution upon the occurrence of a predetermined event.

55. The system of claim 54 wherein the predetermined event comprises an event indicative of financial distress of the financial institution.

56. The system of claim 54 wherein the predetermined event comprises an event indicative of financial distress of the second entity.

57. The system of claim 54 wherein the capital stock for which the preferred stock of the second entity is exchanged is preferred stock of the first entity.

58. A system comprising first and second business entities;
the first entity comprising a financial institution regulated by a regulator and having shares of common stock outstanding;
the second entity comprising a real estate investment trust holding real-estate-related assets and deriving income therefrom;
the second entity further characterized as having shares of preferred stock outstanding;
each share of preferred stock of the second entity associated with an equity contract relating to the purchase by the holder of the preferred stock of common stock of the first entity;
the financial institution having greater Tier 1 or Tier 2 capitalization than it would have in the absence of the second entity.

59. The system of claim 58 wherein the equity contract comprises a forward contract obligating its holder to purchase common stock of the first entity at a date in the future.

60. The system of claim 58 wherein the preferred stock is exchangeable for capital stock of the first entity upon the occurrence of a predetermined event.

61. The system of claim 60 wherein the predetermined event comprises an event indicative of financial distress of the financial institution.

62. The system of claim 60 wherein the predetermined event comprises an event indicative of financial distress of the real estate investment trust.

63. The system of claim 60 wherein the capital stock for which the preferred stock of the real estate investment trust is exchanged is preferred stock of the first entity.

64. A method for use in connection with a corporation rated by a ratings agency and having common stock and possessing first assets and for use in connection with a plurality of investors, the method comprising the steps of:
establishing, by the corporation, a second entity holding real-estate-related assets;
issuing preferred stock of the second entity to the plurality of investors, each share of which is associated with an equity contract relating to the purchase by the holder of the preferred stock of common stock of the first entity;
at the second entity, monitoring to determine whether there are one hundred or more owners of the second entity;
at the second entity, monitoring to determine whether fifty percent or more of the second entity is controlled by five or fewer owners;
at the second entity, paying out at least ninety percent of income of the second entity to shareholders in the form of dividends;
whereby the corporation receives an improved balance of equity versus debt.

65. The method of claim 64 wherein the step of establishing the second entity is performed contemporaneously with the issuing of the preferred stock of the second entity to the plurality of shareholders.

66. The method of claim 64 wherein the equity contract comprises a forward contract obligating the holder of the stock to purchase common stock of the corporation at a date in the future.

67. The method of claim 64 wherein the second entity is a real estate investment trust.

68. The method of claim 64 further comprising the step of:
exchanging the preferred stock of the second entity for capital stock of the corporation upon the occurrence of a predetermined event.

69. The method of claim 68 wherein the predetermined event comprises an event indicative of financial distress of the corporation.

70. The method of claim 68 wherein the predetermined event comprises an event indicative of financial distress of the second entity.

71. The method of claim 68 wherein the capital stock for which the preferred stock of the second entity is exchanged is preferred stock of the corporation.

72. A method for use in connection with a corporation possessing first assets and for use in connection with a plurality of investors, the method comprising the steps of:
establishing, by the corporation, a second entity comprising a real estate investment trust; and
issuing preferred stock of the real estate investment trust to the plurality of investors, each share of which is associated with an equity contract relating to the purchase by the holder of the preferred stock of common stock of the first entity;
whereby the corporation receives an improved balance of equity versus debt.

73. The method of claim 72 wherein the second entity performs the further step of:
monitoring such requirements as allow the second entity to continue as a real estate investment trust.

74. The method of claim 72 wherein the step of establishing the real estate investment trust is performed contemporaneously with the issuing of the preferred stock of the real estate investment trust to the plurality of shareholders.

75. The method of claim 72 wherein the equity contract comprises a forward contract obligating the holder of the stock to purchase common stock of the corporation at a date in the future.

76. The method of claim 72 wherein the real estate investment trust performs the further steps of:
monitoring to determine whether there are one hundred or more owners of the real estate investment trust;
monitoring to determine whether fifty percent or more of the real estate investment trust is controlled by five or fewer owners;
paying out at least ninety percent of the income of the real estate investment trust to shareholders in the form of dividends.

77. The method of claim 72 further comprising the step of:
exchanging the preferred stock of the real estate investment trust for capital stock of the corporation upon the occurrence of a predetermined event.

78. The method of claim 75 wherein the predetermined event comprises an event indicative of financial distress of the corporation.

79. The method of claim 75 wherein the predetermined event comprises an event indicative of financial distress of the real estate investment trust.

80. The method of claim 75 wherein the capital stock for which the preferred stock of the real estate investment trust is exchanged is preferred stock of the corporation.

81. A system comprising first and second business entities; the first entity comprising a corporation and having shares of common stock outstanding;second entity comprising a corporation holding real-estate-related assets and deriving income therefrom;
the second entity further characterized as having shares of preferred stock outstanding;
the second entity having no fewer than 100 owners;
the second entity further characterized in that no five or fewer owners own fifty percent or more of the second entity;
the second entity further characterized as paying out no less than ninety percent of its income to shareholders in the form of dividends;
each share of preferred stock of the second entity associated with an equity contract relating to the purchase by the holder of the preferred stock of common stock of the first entity;
whereas the corporation has an improved balance of equity versus debt than the corporation would have in the absence of the second entity.

82. The system of claim 81 wherein the equity contract comprises a forward contract obligating its holder to purchase common stock of the first entity at a date in the future.

83. The system of claim 81 wherein the first entity is a company that is not a financial institution.

84. The system of claim 83 wherein the second entity is a real estate investment trust.

85. The system of claim 81 wherein the preferred stock is exchangeable for capital stock of the corporation upon the occurrence of a predetermined event.

86. The system of claim 85 wherein the predetermined event comprises an event indicative of financial distress of the corporation.

87. The system of claim 85 wherein the predetermined event comprises an event indicative of financial distress of the second entity.

88. The system of claim 85 wherein the capital stock for which the preferred stock of the second entity is exchanged is preferred stock of the corporation.

89. A system comprising first and second business entities;
the first entity comprising a corporation and having shares of common stock outstanding;
the second entity comprising a real estate investment trust holding real-estate-related assets and deriving income therefrom;
the second entity further characterized as having shares of preferred stock outstanding;
each share of preferred stock of the second entity associated with an equity contract relating to the purchase by the holder of the preferred stock of common stock of the first entity;
whereas the corporation has a better balance of equity versus debt than the corporation would have in the absence of the real estate investment trust.

90. The system of claim 89 wherein the equity contract comprises a forward contract obligating its holder to purchase common stock of the corporation at a date in the future.

91. The system of claim 89 wherein the first entity is a company that is not a financial institution.

92. The system of claim 89 wherein the preferred stock is exchangeable for capital stock of the corporation upon the occurrence of a predetermined event.

93. The system of claim 92 wherein the predetermined event comprises an event indicative of financial distress of the corporation.

94. The system of claim 92 wherein the predetermined event comprises an event indicative of financial distress of the real estate investment trust.

95. The system of claim 92 wherein the capital stock for which the preferred stock of the real estate investment trust is exchanged is preferred stock of the corporation.

96. A method for use in connection with a first entity possessing first assets and for use in connection with a plurality of investors, the method comprising the steps of:
establishing, by the first entity, a second entity holding real-estate-related assets;
issuing preferred stock of the second entity to the plurality of investors, each share of which is associated with an equity contract relating to the purchase by the holder of the preferred stock of common stock of the first entity;
the second entity, paying dividends to the investors; and
at the second entity, deducting from income the dividends paid.

97. The method of claim 96 wherein the step of establishing the second entity is performed contemporaneously with the issuing of the preferred stock of the second entity to the plurality of shareholders.

98. The method of claim 96 wherein the equity contract comprises a forward contract obligating the holder of the stock to purchase common stock of the first entity at a date in the future.

99. The method of claim 96 wherein the second entity is a real estate investment trust.

100. The method of claim 96 further comprising the step of:
exchanging the preferred stock of the second entity for capital stock of the first entity upon the occurrence of a predetermined event.

101. The method of claim 100 wherein the predetermined event comprises an event indicative of financial distress of the first entity.

102. The method of claim 100 wherein the predetermined event comprises an event indicative of financial distress of the second entity.

103. The method of claim 100 wherein the capital stock for which the preferred stock of the second entity is exchanged is preferred stock of the first entity.

104. A method for use in connection with a first entity possessing first assets and for use in connection with a plurality of investors, the method comprising the steps of:
establishing by the first entity, a second entity comprising a real estate investment trust;
issuing preferred stock of the real estate investment trust to the plurality of investors, each share of which is associated with an equity contract relating to the purchase by the holder of the preferred stock of common stock of the first entity;
at the real estate investment trust, paying dividends from the real estate investment trust to the investors; and
at the real estate investment trust, deducting from income the dividends paid.

105. The method of claim 104 wherein the second entity performs the further step of:
monitoring such requirements as allow the second entity to continue as a real estate investment trust.

106. The method of claim 104 wherein the step of establishing the real estate investment trust is performed contemporaneously with the issuing of the preferred stock of the real estate investment trust to the plurality of shareholders.

107. The method of claim 104 wherein the equity contract comprises a forward contract obligating the holder of the stock to purchase common stock of the first entity at a date in the future.

108. The method of claim 104 wherein the real estate investment trust performs the further steps of:
monitoring to determine whether there are one hundred or more owners of the real estate investment trust;to determine whether fifty percent or more of the real estate investment trust is controlled by five or fewer owners;
paying out at least ninety percent of the income of the real estate investment trust to shareholders in the form of dividends.

109. The method of claim 104 further comprising the step of:
exchanging the preferred stock of the real estate investment trust for capital stock of the first entity upon the occurrence of a predetermined event.

110. The method of claim 109 wherein the predetermined event comprises an event indicative of financial distress of the first entity.

111. The method of claim 109 wherein the predetermined event comprises an event indicative of financial distress of the real estate investment trust.

112. The method of claim 109 wherein the capital stock for which the preferred stock of the real estate investment trust is exchanged is preferred stock of the first entity.

113. A system comprising first and second business entities;
the first entity comprising a corporation having shares of common stock outstanding;
the second entity comprising a corporation holding real-estate-related assets and deriving income therefrom;
the second entity further characterized as having shares of preferred stock outstanding;
share of preferred stock of the second entity associated with an equity contract relating to the purchase by the holder of the preferred stock of common stock of the first entity;
the second entity further characterized as being able to deduct dividends paid from its income.

114. The system of claim 113 wherein the equity contract comprises a forward contract obligating its holder to purchase common stock of the first entity at a date in the future.

115. The system of claim 113 wherein the first entity is a financial institution.

116. The system of claim 115 wherein the second entity is a real estate investment trust.

117. The system of claim 113 wherein the preferred stock is exchangeable for capital stock of the first entity upon the occurrence of a predetermined event.

118. The system of claim 117 wherein the predetermined event comprises an event indicative of financial distress of the first entity.

119. The system of claim 117 wherein the predetermined event comprises an event indicative of financial distress of the second entity.

120. The system of claim 117 wherein the capital stock for which the preferred stock of the second entity is exchanged is preferred stock of the first entity.

121. A system comprising first and second business entities;
the first entity comprising a corporation having shares of common stock outstanding;
the second entity comprising a real estate investment trust holding real-estate-related assets and deriving income therefrom;
the second entity further characterized as having shares of preferred stock outstanding;
each share of preferred stock of the second entity associated with an equity contract relating to the purchase by the holder of the preferred stock of common stock of the first entity;
the second entity further characterized as being able to deduct dividends paid from its income.

122. The system of claim 121 wherein the equity contract comprises a forward contract obligating its holder to purchase common stock of the first entity at a date in the future.

123. The system of claim 121 wherein the first entity is a financial institution.

124. The system of claim 121 wherein the first entity is a company that is not a financial institution.

125. The system of claim 121 wherein the preferredsi stock is exchangeable for capital stock of the first entity upon the occurrence of a predetermined event.

126. The system of claim 125 wherein the predetermined event comprises an event indicative of financial distress of the first entity.

127. The system of claim 125 wherein the predetermined event comprises an event indicative of financial distress of the second entity.

128. The method of claim 125 wherein the capital stock for which the preferred stock of the real estate investment trust is exchanged is preferred stock of the first entity.

129. A method for use in connection with a financial institution regulated by a regulator and possessing first assets, the method for use in connection with a plurality of investors, the method comprising the steps of:
establishing, by the financial institution, a second entity holding real-estate-related assets;
issuing preferred stock of the second entity to the plurality of investors, each share of which is associated with an equity contract relating to the purchase by the holder of the preferred stock of common stock of the first entity;
at the second entity, deducting dividends paid to the investors from its income;
whereby the Tier 1 or Tier 2 capitalization of the ehfinancial institution is increased.

130. The method of claim 129 wherein the step of establishing the second entity is performed contemporaneously with the issuing of the preferred stock of the second entity to the plurality of shareholders.

131. The method of claim 129 wherein the equity contract comprises a forward contract obligating the holder of the stock to purchase common stock of the financial institution at a date in the future.

132. The method of claim 129 wherein the second entity is a real estate investment trust.

133. The method of claim 129 further comprising the step of:
exchanging the preferred stock of the second entity for capital stock of the financial institution upon the occurrence of a predetermined event.

134. The method of claim 133 wherein the predetermined event comprises an event indicative of financial distress of the financial institution.

135. The method of claim 133 wherein the predetermined event comprises an event indicative of financial distress of the second entity.

136. The method of claim 133 wherein the capital stock for which the preferred stock of the second entity is exchanged is preferred stock of the financial institution.

137. A method for use in connection with a financial institution regulated by a regulator and possessing first assets, the method for use in connection with a plurality of investors, the method comprising the steps of:
establishing, by the financial institution, a second entity comprising a real estate investment trust;
issuing preferred stock of the real estate investment trust to the plurality of investors, each share of which is associated with an equity contract relating to the purchase by the holder of the preferred stock of common stock of the first entity;
deducting from the income of the real estate investment trust dividends paid to the investors;
whereby the Tier 1 or Tier 2 capitalization of the financial institution is increased.

138. The method of claim 137 wherein the second entity performs the further step of:
monitoring such requirements as allow the second entity to continue as a real estate investment trust.

139. The method of claim 137 wherein the step of establishing the real estate investment trust is performed contemporaneously with the issuing of the preferred stock of the real estate investment trust to the plurality of shareholders.

140. The method of claim 137 wherein the equity contract comprises a forward contract obligating the holder of the stock to purchase common stock of the financial institution at a date in the future.

141. The method of claim 137 wherein the real estate investment trust performs the further steps of:
monitoring to determine whether there are one hundred or more owners of the real estate investment trust;
monitoring to determine whether fifty percent or more of the real estate investment trust is controlled by five or fewer owners;
paying out at least ninety percent of the income of the real estate investment trust to shareholders in the form of dividends.

142. The method of claim 137 further comprising the step of:
exchanging the preferred stock of the real estate investment trust for capital stock of the financial institution upon the occurrence of a predetermined event.

143. The method of claim 142 wherein the predetermined event comprises an event indicative of financial distress of the financial institution.

144. The method of claim 142 wherein the predetermined event comprises an event indicative of financial distress of the real estate investment trust.

145. The method of claim 142 wherein the capital stock for which the preferred stock of the real estate investment trust is exchanged is preferred stock of the financial institution.

146. A system comprising first and second business entities;
the first entity comprising a financial institution regulated by a regulator and having shares of common stock outstanding;
the second entity comprising a corporation holding real-estate-related assets and deriving income therefrom;
the second entity further characterized as having shares of preferred stock outstanding;
each share of preferred stock of the second entity associated with an equity contract relating to the purchase by the holder of the preferred stock of common stock of the first entity the second entity characterized as being able to deduct dividends paid from its income;
the financial institution having greater Tier 1 or Tier 2 capitalization than it would have in the absence of the second entity.

147. The system of claim 146 wherein the equity contract comprises a forward contract obligating its holder to purchase common stock of the financial institution at a date in the future.

148. The system of claim 146 wherein the second entity is a real estate investment trust.

149. The system of claim 146 wherein the preferred stock is exchangeable for capital stock of the financial institution upon the occurrence of a predetermined event.

150. The system of claim 149 wherein the predetermined event comprises an event indicative of financial distress of the financial institution.

151. The system of claim 149 wherein the predetermined event comprises an event indicative of financial distress of the second entity.

152. The system of claim 149 wherein the capital stock for which the preferred stock of the second entity is exchanged is preferred stock of the first entity.

153. A system comprising first and second business entities;
the first entity comprising a financial institution regulated by a regulator and having shares of common stock outstanding;
the second entity comprising a real estate investment trust holding real-estate-related assets and deriving income therefrom;
the second entity further characterized as having shares of preferred stock outstanding;
each share of preferred stock of the second entity associated with an equity contract relating to the purchase by the holder of the preferred stock of common stock of the first entity;
the second entity characterized as being able to deduct dividends paid from its income;
the financial institution having greater Tier 1 or Tier 2 capitalization than it would have in the absence of the second entity.

154. The system of claim 153 wherein the equity contract comprises a forward contract obligating its holder to purchase common stock of the first entity at a date in the future.

155. The system of claim 153 wherein the preferred stock is exchangeable for capital stock of the first entity upon the occurrence of a predetermined event.

156. The system of claim 155 wherein the predetermined event comprises an event indicative of financial distress of the financial institution.

157. The system of claim 155 wherein the predetermined event comprises an event indicative of financial distress of the real estate investment trust.

158. The system of claim 155 wherein the capital stock for which the preferred stock of the real estate investment trust is exchanged is preferred stock of the first entity.

159. A method for use in connection with a corporation having common stock and possessing first assets and for use in connection with a plurality of investors, the method comprising the steps of:
establishing, by the corporation, a second entity holding real-estate-related assets;
issuing preferred stock of the second entity to the plurality of investors, each share of which is associated with an equity contract relating to the purchase by the holder of the preferred stock of common stock of the first entity;
at the second entity, deducting dividends paid to the investors from its income;
whereby the corporation receives an improved balance of equity versus debt.

160. The method of claim 159 wherein the step of establishing the second entity is performed contemporaneously with the issuing of the preferred stock of the second entity to the plurality of shareholders.

161. The method of claim 159 wherein the equity contract comprises a forward contract obligating the holder of the stock to purchase common stock of the corporation at a date in the future.

162. The method of claim 159 wherein the second entity is a real estate investment trust.

163. The method of claim 159 further comprising the step of:
exchanging the preferred stock of the second entity for capital stock of the corporation upon the occurrence of a predetermined event.

164. The method of claim 163 wherein the predetermined event comprises an event indicative of financial distress of the corporation.

165. The method of claim 163 wherein the predetermined event comprises an event indicative of financial distress of the second entity.

166. The method of claim 163 wherein the capital stock for which the preferred stock of the second entity is exchanged is preferred stock of the corporation.

167. A method for use in connection with a corporation possessing first assets and for use in connection with a plurality of investors, the method comprising the steps of:
establishing, by the corporation, a second entity comprising a real estate investment trust;
issuing preferred stock of the real estate investment trust to the plurality of investors, each share of which is associated with an equity contract relating to the purchase by the holder of the preferred stock of common stock of the first entity;
at the real estate investment trust, deducting dividends paid from its income;
whereby the corporation receives an improved balance of equity versus debt.

168. The method of claim 165 wherein the second entity performs the further step of:
monitoring such requirements as allow the second entity to continue as a real estate investment trust.

169. The method of claim 165 wherein the step of establishing the real estate investment trust is performed contemporaneously with the issuing of the preferred stock of the real estate investment trust to the plurality of shareholders.

170. The method of claim 165 wherein the equity contract comprises a forward contract obligating the holder of the stock to purchase common stock of the corporation at a date in the future.

171. The method of claim 165 wherein the real estate investment trust performs the further steps of:
monitoring to determine whether there are one hundred or more owners of the real estate investment trust;
monitoring to determine whether fifty percent or more of the real estate investment trust is controlled by five or fewer owners;
paying out at least ninety percent of the income of the real estate investment trust to shareholders in the form of dividends.

172. The method of claim 165 further comprising the step of:
exchanging the preferred stock of the real estate investment trust for capital stock of the corporation upon the occurrence of a predetermined event.

173. The method of claim 172 wherein the predetermined event comprises an event indicative of financial distress of the corporation.

174. The method of claim 172 wherein the predetermined event comprises an event indicative of financial distress of the real estate investment trust.

175. The method of claim 172 wherein the capital stock for which the preferred stock of the real estate investment trust is exchanged is preferred stock of the corporation.

176. A system comprising first and second business entities;
the first entity comprising a corporation and having shares of common stock outstanding;
the second entity comprising a corporation holding real-estate-related assets and deriving income therefrom;
the second entity further characterized as having shares of preferred stock outstanding;
each share of preferred stock of the second entity associated with an equity contract relating to the purchase by the holder of the preferred stock of common stock of the first entity;
the second entity characterized as being able to deduct dividends paid from income;
the corporation having a better balance of equity versus debt than the corporation would have in the absence of the second entity.

177. The system of claim 176 wherein the equity contract comprises a forward contract obligating its holder to purchase common stock of the first entity at a date in the future.

178. The system of claim 176 wherein the first entity is a company that is not a financial institution.

179. The system of claim 178 wherein the second entity i hat ists a real estate investment trust.

180. The system of claim 174 wherein the preferred stock is exchangeable for capital stock of the corporation upon the occurrence of a predetermined event.

181. The system of claim 180 wherein the predetermined event comprises an event indicative of financial distress of the corporation.

182. The system of claim 180 wherein the predetermined event comprises an event indicative of financial distress of the second entity.

183. The system of claim 180 wherein the capital stock for which the preferred stock of the second entity is exchanged is preferred stock of the corporation.

184. A system comprising first and second business entities;
the first entity comprising a corporation and having shares of common stock outstanding;
the second entity comprising a real estate investment trust holding real-estate-related assets and deriving income therefrom;
second entity further characterized as having shares of preferred stock outstanding;
each share of preferred stock of the second entity associated with an equity contract relating to the purchase by the holder of the preferred stock of common stock of the first entity;
the second entity characterized as being able to deduct dividends paid from income;
the corporation having a better balance of equity versus debt than the corporation would have in the absence of the real estate investment trust.

185. The system of claim 184 wherein the equity contract comprises a forward contract obligating its holder to purchase common stock of the corporation at a date in the future.

186. The system of claim 184 wherein the first entity is a company that not a financial institution.

187. The system of claim 184 wherein the preferred st aock is exchangeable for capital stock of the corporation upon the occurrence of a predetermined event.

188. The system of claim 187 wherein the predetermined event comprises an event indicative of financial distress of the corporation.

189. The system of claim 187 wherein the predetermined event comprises an event indicative of financial distress of the real estate investment trust.

190. The system of claim 187 wherein the capital stock for which the preferred stock of the real estate investment trust is exchanged is preferred stock of the corporation.

191. A financial instrument comprising:
a preferred share of a real estate investment trust, a forward contract obligating the holder of the preferred share to purchase, at a future date, common stock of an entity owning common stock of the real estate investment trust.

192. The instrument of claim 191 further characterized in that the preferred share is exchangeable for capital stock of the entity owning common stock of the real estate investment trust upon the occurrence of a predetermined event.

193. The financial instrument of claim 192 wherein the predetermined event comprises an event indicative of financial distress of the entity owning common stock of the real estate investment trust.

194. The method of claim 192 wherein the predetermined event comprises an event indicative of financial distress of the real estate investment trust.

195. The method of claim 192 wherein the capital stock for which the preferred stock of the real estate investment trust is exchanged is preferred stock of the entity owning common stock of the real estate investment trust.
